(19) United States
(12) Patent Application Publication
(10) Pub. No.: US 2023/0345451 A1
(43) Pub. Date: Oct. 26, 2023

(54) MULTI-USER SCHEDULING METHOD AND SYSTEM BASED ON REINFORCEMENT LEARNING FOR 5G IOT SYSTEM

(71) Applicant: State Grid Jiangsu Electric Power Co., LTD, Nanjing Power Supply Branch, Nanjing (CN)

(72) Inventors: Wendi WANG, Nanjing (CN); Hong ZHU, Nanjing (CN); Pu WANG, Nanjing (CN); Honghua XU, Nanjing (CN); Su PAN, Nanjing (CN); Dongxu ZHOU, Nanjing (CN); Xin QIAN, Nanjing (CN); Zibo LI, Nanjing (CN); Xuanxuan SHI, Nanjing (CN); Junkang WANG, Nanjing (CN); Zhongzhong XU, Nanjing (CN); Jun ZHAO, Nanjing (CN)

(73) Assignee: State Grid Jiangsu Electric Power Co., LTD, Nanjing Power Supply Branch, Nanjing (CN)

(21) Appl. No.: 18/096,785

(22) Filed: Jan. 13, 2023

(30) Foreign Application Priority Data
Apr. 21, 2022 (CN) 202210420438.X

(51) Int. Cl. H04W 72/121; H04W 72/50

(52) U.S. Cl. CPC H04W 72/121; H04W 72/535

(57) ABSTRACT

A multi-user scheduling method based on reinforcement learning for 5G IoT, including: calculating the achievable rate of each user in a set according to a communication scenario model; generating an initial scheduled users set according to the achievable rate of each user; according to the achievable rate of each user and the number of times each user is scheduled, evaluating the estimated value of each user's action value under the current scheduling period by using the Q-learning method; determining the upper bound value of the confidence interval of each user's action value; determining the set of scheduled users under the current scheduling period according to the upper bound of the confidence interval of each user's action value; according to the set of scheduled users under the current scheduling period, recalculating the actual achievable rate value of each selected user under the current scheduling period.

### RELATED APPLICATIONS

The present patent document claims the benefit of priority to CN Patent Application No. 202210420438. X, filed on Apr. 21, 2022, and entitled “A multi-user scheduling method and system based on reinforcement learning for 5G IoT system”, the entire contents of which are incorporated herein by reference.

### TECHNICAL FIELD

The present disclosure relates to the wireless communication technologies, and more particularly, relates to a multi-user scheduling method and related system based on reinforcement learning for a 5G (Fifth Generation) IoT (Internet of Things) system.

### BACKGROUND

With the continuous developments of 5G, more IoT applications have been supported. However, due to the massive number of nodes in the IoT, the 5G network is required to support great amount access users. Massive multi-user MIMO (multiple-input and multiple-output) technology is one of the effective ways to achieve the above-mentioned requirement. Its essential idea is to configure a great number of antennas at base stations and to support multi-user communication simultaneously by dividing the space resources, which enables a system to serve multiple users on same time-frequency resources. As most IoT (Internet of Things) services are not continuous in time, a system will accept more users to connect than the users who can communicate simultaneously in order to improve the utilization rate of resources. In each scheduling period, the system selects a batch of users from all connected users and allocates resources to the batch of users, i.e., multi-user scheduling. Upon the multi-user scheduling technology, the utilization rate of the system resources and the performance of the system can be improved significantly. Regarding 5G IoT node scheduling, two changes currently exist: I. how to reduce the computational complexity of IoT nodes scheduling algorithms is one of the key points for large-scale applications of 5G IoT, as the limited computing power of nodes of IoT systems, and most industrial IoTs have strict latency requirements; II. how to determine the goal of users scheduling, the goal is usually to maximize the throughput of the total system (sum of users' throughput) or energy efficiency (throughput/energy) without exceeding the maximum number of scheduled users. While ensuring system performance, it is necessary to consider some nodes with poor channel conditions to avoid these nodes being difficult to be scheduled always, so as to resulting in the loss of basic data transmission opportunities, and then causing “extremely unfair” phenomenon.

Whether the scheduling criterion is to maximize the total throughput of the system or maximize the energy efficiency, it involves the calculation of the users' achievable rate, which will involve massive amount of matrix singular value decomposition (SVD) calculations, and the amount of calculation is enormous. Meanwhile, the users' achievable rate is related to the combination of the scheduled users (which is related to the user joint channel matrix), so the optimal users' combination needs to be exhaustive. Currently, two methods may reduce the computational complexity of the scheduling algorithm, wherein a first methodology is to simplify the calculation of the achievable rate, and a second methodology is to replace or update the exhaustive algorithm. Some present existing literatures focus on the first methodology to reduce the amount of computation, and the related scheduling method is essentially a greedy algorithm, which reduces the complexity of the algorithm by adopting the low-complexity representation of the users' achievable rate. Furthermore, some existing methods need to pre-calculate the achievable rate of each user when selecting users, and the achievable rate is related to the user's channel matrix and the joint channel matrix. Therefore, different users' combinations need to be considered, and multiple matrix SVDs are required to calculate the achievable rate, and the computational complexity reaches O(M₀T³). While in the 5G IoT system, along with the massive increase in the number of access users, the number of base station antennas, and the maximum number of scheduled users, the calculation amount of the user scheduling algorithm needs to be further reduced to ensure the scheduling delay and performance of the system.

### SUMMARY

To solve the deficiencies in the present existing technologies, the purpose of the present disclosure is to achieve lower computational complexity in resolving the user scheduling problem of the 5G IoT systems and to ensure that the long-term performance of the system is not weaker than existing scheduling algorithms. Therefore, a multi-user scheduling method based on reinforcement learning for 5G IoT system is proposed.

The present disclosure proposes the following methods.

A multi-user scheduling method based on reinforcement learning for a 5G IoT (Internet of Things system), and the method comprises the following steps.

Step (a): The method calculates a achievable rate of each user in a set, according to the communication scenario model of the 5G IoT, and (b): generates an initial scheduled users set according to the actual achievable rate or achievable rate of the each user. Furthermore, (c): according to the achievable rate of the each user and a number of times the each user being scheduled, the method evaluates an estimated value of an action value of the each user under a current scheduling period via utilizing Q-learning method. Then, (d): the method obtains an upper bound value of a confidence interval for the action value of the each user and then (e): determining a scheduled users set in the current scheduling period according to the upper bound value of the confidence interval of the action value of the each user. (f): The method calculates again the achievable rate of the each selected user under the current scheduling period according to the scheduled users set under the current scheduling period. Specially, (g): the method returns to (c) until the estimated value of the action value of the each user converges to the achievable rate of the each user in the current scheduling period, and then outputs the scheduled users set in (e) performed at last time as a result of a next scheduling period.

Specially, the step (a) further comprises that the achievable rate Rₘ of a user m is

$${R}_{m} = {\sum }_{n = 1}^{{N}_{m}} {log}_{2} ( 1 + \frac{{P}_{m , n} {λ}_{m , n}^{2}}{{σ}^{2}} )$$

wherein, P_{m,n} is the transmission power of the user m in a parallel channel n, σ2 is an additive white Gaussian noise power, λ_{m,n} is a non-zero singular value of Hₘ [symbol] ₘ⁰, and Nₘ is a number of antennas of the user m, specially:

$${ℍ}_{m} = ( \begin{matrix}{H}_{1} \\ ⋮ \\ {H}_{m - 1} \\ {H}_{m + 1} \\ ⋮ \\ {H}_{M}\end{matrix} ) = ( \begin{matrix}{𝕌}_{m}^{1} & {𝕌}_{m}^{0}\end{matrix} ) ( \begin{matrix}0 \\ 0\end{matrix} ) {( \begin{matrix}{𝕍}_{m}^{1} & {𝕍}_{m}^{0}\end{matrix} )}^{H}$$

$${H}_{m} {𝕍}_{m}^{0} = \begin{matrix}( {U}_{m}^{1} & {U}_{m}^{0} )\end{matrix} ( \begin{matrix}{\sum }_{m}^{1} & 0 \\ 0 & 0\end{matrix} ) {( {V}_{m}^{1} {V}_{m}^{0} )}^{H}$$

Wherein [symbol] ₘ is a joint matrix of the channel matrices of other users except the user m, and the above formula is the singular value decomposition of [symbol] ₘ.

Wherein step (b) further comprises:
(b1). defining the scheduled users set Ψ=Ø, and the set of all users A={M₀} in the environment;
(b2). for each user x in the set A−Ψ, defining Ψₓ=Ψ+{x}, and calculate the data rate R_{Ψ}_{ₓ} of each Ψₓ as:

$${R}_{{Ψ}_{x}} = {\sum }_{m ∈ {Ψ}_{x}} {R}_{m}$$

wherein, Rₘ representing the achievable rate of user m;
(b3). updating the scheduled users set Ψ=Ψ+{x*}, wherein, the user x* is x*=argmax_{x∈Ψ}R_{Ψ}_{ₓ};
(b4). returning to (b2), until |Ψ|=M, then the initial scheduled users set is π₀=Ψ, wherein, the maximum number M of users that can be scheduled at same time is determined by:

$${\sum }_{i = 1 , i \neq m}^{M} {N}_{i} \leq T$$

Wherein, T is an amount number of antennas, Nᵢ is a number of antennas for the each user.

Wherein step (c) further comprises:
an estimated value of action values \tilde{q}ₐ_{ᵢ}(t) of a user i is:

$${\tilde{q}}_{{a}_{i}} ( t ) = \{ \begin{matrix}\frac{1}{{\hat{τ}}_{{a}_{i}} ( t )} {\sum }_{τ = 0}^{t} {β}^{t - τ} {r}_{i , τ} * I ( {a}_{i} ∈ {π}_{τ} ) , {\hat{τ}}_{{a}_{i}} ( t ) \neq 0 \\ 0 , {\hat{τ}}_{{a}_{i}} ( t ) = 0\end{matrix}$$

wherein \hat{τ}ₐ_{ᵢ}(t) represents the number of times that user i is scheduled in the scheduling period 0, 1, . . . , t, I(⋅) is the indicator function, the function value is 1 if the event in the parentheses is established, otherwise the function value is 0;
β∈(0,1) is the discount factor; r_{i,τ} is the achievable rate of user i in the τ-th scheduling period.
Furthermore, the estimated value of action values \tilde{q}ₐ_{ᵢ}(t) of a user i is simplified as:

$${\tilde{q}}_{{a}_{i}} ( t ) = \{ \begin{matrix}\begin{matrix}\frac{β {\tilde{q}}_{{a}_{i}} ( t - 1 ) {\hat{τ}}_{{a}_{i}} ( t - 1 ) + {r}_{i , t}}{{\hat{τ}}_{{a}_{i}} ( t - 1 ) + 1} , & {a}_{i} ∈ {π}_{τ}\end{matrix} \\ \begin{matrix}β {\tilde{q}}_{{a}_{i}} ( t - 1 ) , & {a}_{i} ∉ {π}_{τ}\end{matrix}\end{matrix}$$

$$= \{ \begin{matrix}\begin{matrix}β {\tilde{q}}_{{a}_{i}} ( t - 1 ) + \frac{1}{{\hat{τ}}_{{a}_{i}} ( t )} [ {r}_{i , t} - β {\tilde{q}}_{{a}_{i}} ( t - 1 ) ] , & {a}_{i} ∈ {π}_{τ}\end{matrix} \\ \begin{matrix}β {\tilde{q}}_{{a}_{i}} ( t - 1 ) , & {a}_{i} ∉ {π}_{τ}\end{matrix}\end{matrix}$$

Wherein, t≥1.

Wherein step (d) further comprises:

the upper bound value of the confidence interval Qₐ_{ᵢ}(t) of a user i:

$${Q}_{{a}_{i}} ( t ) = {\tilde{q}}_{{a}_{i}} ( t ) + \sqrt{\frac{M ln ( t + 1 )}{{\hat{τ}}_{{a}_{i}} ( t )}}$$

Wherein, M is a maximum number of users that can be scheduled at the same time.

Wherein step (g) further comprises the action value of the each user converges to the achievable rate of the each user, includes:

$$\sqrt{\frac{M ln ( t + 1 )}{{\hat{τ}}_{{a}_{i}} ( t )}} \to 0$$

Wherein step (e) further comprises:

the scheduled users set πₜ in the current scheduling period is:

$${π}_{t} = arg {max}_{{π}_{t}} {\sum }_{i ∈ {π}_{t}} {Q}_{{a}_{i}} ( t )$$

wherein, Qₐ_{ᵢ}(t) is the upper bound value of the confidence interval of any user i, and πₜ is the maximum value of the sum of Qₐ_{ᵢ}(t).
If the current scheduling period is the first scheduling period, setting the estimated value of each user's action value \tilde{q}ₐ_{ᵢ}(0)=0.
A multi-user scheduling system based on reinforcement learning for a 5G IoT (Internet of Things system), and the system comprises a performance computing module and a logic operating module.

The performance computing module computes the achievable rate of an each user in a scheduled users set and utilizes the achievable rates of the each user as a historical rate of the each user to provide a function for the multi-user scheduling system to evaluate the each user's action value.

The logic operating module generates an initial scheduled users set, evaluates an estimated value of the each user's action value under a current scheduling period, determines an upper bound value of a confidence interval of the each user's action value, and determines the scheduled users set under the current scheduling period.

The present disclosure, compared with the existing technologies, has the following advantages:
(a). Utilizing the method of the present disclosure, the base station can directly select M optimal users without trying different user combinations. Therefore, the amount of computing is reduced, and the system performance after the method converges is not lower than the performance of the existing algorithms.
(b). The method adopts the “exploration” operation, which not only improves the accuracy of each user's estimated value of the action value and the long-term throughput of the system, but also solves the “extremely unfair” issue.

### BRIEF DESCRIPTION OF THE DRAWINGS

FIG. 1 is a schematic diagram of a multi-user scheduling method based on reinforcement learning for a 5G IoT system, according to some exemplary embodiments of the present disclosure;

FIG. 2 is a schematic diagram of the communication scenario model established for the characteristics of the 5G IoT system, according to some exemplary embodiments of the present disclosure;

FIG. 3 is flow chart of the user scheduling method of the present disclosure, according to some exemplary embodiments of the present disclosure;

FIG. 4 is a schematic diagram of convergence time situation of the present disclosure, according to some exemplary embodiments of the present disclosure;

FIG. 5 is a schematic diagram of comparison of the system throughput after convergence of the method of the present disclosure and other scheduling algorithms, according to some exemplary embodiments of the present disclosure;

FIG. 6 is a schematic diagram of comparison of user scheduling delay of the method of the present disclosure and other scheduling algorithms, according to some exemplary embodiments of the present disclosure.

### DETAILED DESCRIPTION

The present disclosure will be further described below with reference to the accompanying drawings. The following examples are only aimed to illustrate the technical solutions of the present disclosure more clearly, but the examples may not limit the protection scope of the present disclosure.

The present disclosure proposes a multi-user scheduling method based on reinforcement learning for the 5G Internet of Things system. Specially, the method estimates the estimated value of the user's action value from the user's historical achievable rate samples by using Q-learning method and selects users according to the Q values (the upper bound value of the confidence interval of the estimated values of the action values). After the users being selected, the base station calculates the achievable rate of each selected user. Compared with the traditional user scheduling algorithm, this method needs to collect the historical achievable rates of each user as samples to evaluate the action value. It is necessary to collect the samples as many as possible, so that the action value can be estimated more accurately, so it takes time to make the method converge. However, the proposed user scheduling method does not need to try varieties of different user combinations before scheduling, which can reduce a lot of unnecessary calculation of the achievable rates, so the computational complexity has been reduced, and the optimal scheduled users set can still be obtained after the method converges, and then to ensure optimal the performance of the system.

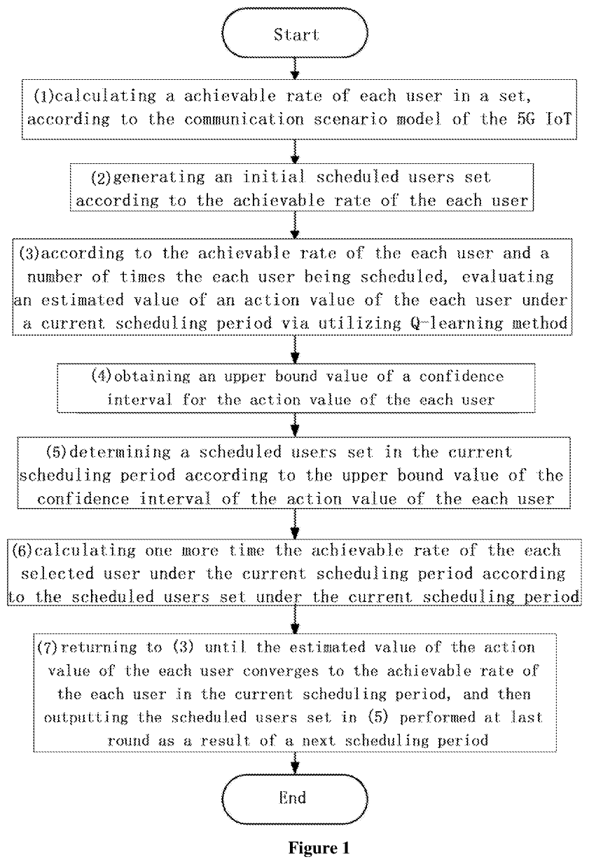

As shown in FIG. 1, the technical solution adopted by the present disclosure is: a multi-user scheduling method based on reinforcement learning for the 5G IoT. For general, the method may include the following steps:
(1) according to the characteristics of the 5G IoT communication system, establishing a corresponding communication scenario model, generating an initial scheduled users set, and calculating the achievable rate or the actual achievable rates of each user in the set, wherein the achievable rate or the actual achievable rates are considered as the user's historical achievable rate samples;
(2) according to each user's historical achievable rate samples, evaluating the estimated value of each user's action value by the Q-learning method at the current scheduling period;
(3) calculating the upper bound value of the confidence interval of the estimated value of the users' action value by utilizing the confidence upper bound method to balance exploration and utilization, and then selecting the users according to the upper bound value of the confidence interval. After selecting users, the base station recalculates the actual achievable rate or achievable rate of each selected user. It should be noted that the achievable rate is used to re-update the estimated value of each user's action value in step (2);
(4) repeating steps (2) and (3). After the method converges, the estimated value of the user's action value is equal to the actual achievable rate or achievable rate of the user. At this time, the user selected by the base station via scheduling step (3) can achieve the highest system performance.

Furthermore, the communication scenario model of the 5G IoT system, in the step (1), the received signal yₘ of the user m can be described as:

$${y}_{m} = {H}_{m} {T}_{m} {s}_{m} + {H}_{m} {\sum }_{i = 1 , i \neq m}^{M} {T}_{i} {s}_{i} + {n}_{m} \qquad ( 1 )$$

where sₘ is the transmitted signal of user m, Hₘ is the channel matrix of user m, Tₘ is the precoding matrix of user m, and nₘ is additive white Gaussian noise. It is necessary to eliminate the signal interference of other users via BD precoding, and the main principle of BD precoding is to set the precoding matrix of each user as the null space matrix of the joint channel matrix (which is formed by splicing the channel matrix of other users except this user), and moreover the null space matrix is multiplied by other user's channel matrix equal to 0. Set [symbol] ₘ to be the joint matrix of the channel matrices of other users except user m, and perform SVD (Singular Value Decomposition) on it:

$${ℍ}_{m} = ( \begin{matrix}{H}_{1} \\ ⋮ \\ {H}_{m - 1} \\ {H}_{m + 1} \\ ⋮ \\ {H}_{m}\end{matrix} ) = ( \begin{matrix}{𝕌}_{m}^{1} & {𝕌}_{m}^{0}\end{matrix} ) ( \begin{matrix} \\ 0\end{matrix} \begin{matrix}0 \\ 0\end{matrix} ) ( {\begin{matrix}{𝕍}_{m}^{1} & {𝕍}_{m}^{0} )\end{matrix}}^{H} \qquad ( 2 )$$

Wherein, [symbol] ₘ⁰, [symbol] ₘ⁰ are composed of left and right singular vectors corresponding to zero singular values of joint matrix [symbol] ₘ, [symbol] ₘ¹, [symbol] ₘ¹ are composed of left and right singular vectors corresponding to non-zero singular values of [symbol] ₘ, and the main diagonal elements of the diagonal matrix [symbol] ₘ are the non-zero singular values of [symbol] ₘ. As [symbol] ₘ⁰ exists in the null space of the joint matrix [symbol] ₘ, then:

$${H}_{m} {\sum }_{i = 1 , i \neq m}^{M} {𝕍}_{i}^{0} {s}_{i} = 0 \qquad ( 3 )$$

Therefore, performing precoding processing on the transmitted signal of user m by utilizing [symbol] ₘ⁰, the inter-user interference can be eliminated completely.

In order to ensure that the null space has non-zero solutions, the number of rows of [symbol] ₘ should not be greater than the number of columns of [symbol] ₘ, then:

$${\sum }_{i = 1 , i \neq m}^{M} {N}_{i} \leq T \qquad ( 4 )$$

Equation (4) is the constraint expression of the maximum number M of users those can be scheduled simultaneously, which can be used to solve the maximum number M of users that can be scheduled at the same time. Wherein, T is the number of antennas, and Nᵢ is the number of antennas for each user.

Set the precoding matrix Tₘ= [symbol] ₘ⁰Vₘ¹(m=1, 2, . . . , M), wherein Vₘ¹ is obtained by Hₘ [symbol] ₘ⁰ through singular value decomposition:

$${H}_{m} {𝕍}_{m}^{0} = ( \begin{matrix}{U}_{m}^{1} & {U}_{m}^{0}\end{matrix} ) ( \begin{matrix}{\sum }_{m}^{1} & 0 \\ 0 & 0\end{matrix} ) {( \begin{matrix}{V}_{m}^{1} & {V}_{m}^{0}\end{matrix} )}^{H} \qquad ( 5 )$$

Wherein, Σₘ¹ is a diagonal matrix, and its main diagonal elements are the non-zero singular values of Hₘ [symbol] ₘ⁰, which are represented by λ_{m,n} and has Nₘ non-zero singular values in total.

Substituting Tₘ into (1), it can get:

yₘ=Hₘ [symbol] ₘ⁰Vₘ¹sₘ+nₘ=Uₘ¹Σₘ¹sₘ+nₘ (6)

Therefore, each user's channel can be equivalent to multiple parallel channels. The actual achievable rate or achievable rate Rₘ of user m is:

$${R}_{m} = {\sum }_{n = 1}^{{N}_{m}} {log}_{2} ( 1 + \frac{{P}_{m , n} {λ}_{m , n}^{2}}{{σ}^{2}} ) \qquad ( 7 )$$

wherein P_{m,n} is the transmission power of user m in parallel channel n, and the transmission power of all parallel channels is preset to 0.1 W in the present disclosure, λ_{m,n} is the non-zero singular value of Hₘ [symbol] ₘ⁰, n=1, 2, . . . , Nₘ. Furthermore, σ² is the additive white Gaussian noise power.

In order to improve the utilization rate of space resources, the system can allow the number of access users M₀ to exceed the maximum number of users M those can communicate simultaneously. In each scheduling period, the system needs to select M users from M₀ users according to the achievable rate. Assuming the scheduled users set is Ψ, and then the system throughput R_{Ψ} is:

$${R}_{Ψ} = {\sum }_{m ∈ Ψ} {R}_{m} = {\sum }_{m ∈ Ψ} {\sum }_{n = 1}^{{N}_{m}} {log}_{2} ( 1 + \frac{{P}_{m , n} {λ}_{m , n}^{2}}{{σ}^{2}} ) \qquad ( 8 )$$

It should be noted that the system throughput R_{Ψ} is equal to the total system data rate multiplied by the length of the scheduling period, and then maximizing system throughput is equivalent to maximizing the total data rate of the system in the case of constant time length. In the present disclosure, the time length is regarded as the unit time, so R_{Ψ} can also represent the system throughput.

The present disclosure utilizes the learning ability of reinforcement learning for an unknown environment to find the optimal scheduled users set through the iteration of Q value evaluation and scheduled set update so that to achieve the goal of maximizing the total throughput of the system. The proposed reinforcement learning model consists of three main components: Agent, Action, and Reward, which are mapped to the user scheduling of the 5G IoT system:

Agent:

The agent is the executive subject of reinforcement learning, which is the base station in the present disclosure. In the environment where the agent is located, a total of M₀ users can be selected for access, from which M users (M is the maximum number of scheduled users) need to be selected for service. The state of the agent is represented by the scheduled users in this period.

Action:

Action aᵢ indicates the action that the base station selects user i to access, and after the action aᵢ is executed in the scheduling period t, the agent's state transitions: adding user i to the scheduled users set Ψₜ. The same action cannot be repeated in a scheduling period, and M actions need to be executed, Action set A={M₀}. The scheduled users set for period t is πₜ, and its modulus |nₜ|=M, also πₜ⊂M₀.

Reward:

After performing the action, the environment may feedback a gain or action gain to the agent. Since a achievable rate of a user may be affected by the joint channel matrix, and the subsequent users' selection will affect the achievable rate of the previous user, therefore, the gain or the action gain, i.e., the user's achievable rate, be calculated after a round of scheduling. Specially, the gain or actual gain rᵢ(t) obtained by the base station after performing the action aᵢ in the period t is the achievable rate of the selected user i in this round of scheduling, which is obtained by equation (7). The total gain obtained by the base station after the end of the scheduling period is Gₜ=Σ_{i∈π}_{ₜ}rᵢ(t).

To generate an initial scheduled users set, the steps are as listed below:
Step (1.1): setting the scheduled users set Ψ=Ø, and the set of all users in the environment A={M₀}.
Step (1.2): for each user x in the set A−Ψ, setting Ψₓ=Ψ+{x}, and calculating the data rate or rate R_{Ψ}_{ₓ} of each Ψₓ according to equation (8). It should be noted that the data rate R_{Ψ}_{ₓ} here can be understood as the system throughput, and Ψ and Ψₓ are essentially same, i.e., both are sets.

Finding the user m* that satisfies the condition x*=argmax_{m∈A-Ψ}R_{Ψ}_{ₓ}, and updating the scheduled users set Ψ=Ψ+{m*}. It should be noted that, x∈A−Ψ, the formula means to find the user m*, from the set A−Ψ, that maximizes the system throughput.
Step (1.3): repeating step (1.2) until |Ψ|=M, and the initial scheduled users set π₀=Ψ. The achievable rate r_{i,0} of user i,

$${r}_{i , 0} = \{ \begin{matrix}{\sum }_{n = 1}^{{N}_{i}} {log}_{2} ( 1 + \frac{{P}_{i , n} {λ}_{i , n}^{2}}{{σ}^{2}} ) , \\ 0 , i ∉ {π}_{0}\end{matrix}$$

i∈π₀,

Wherein, the total gain, earned by the base station,

$${R}_{{π}_{0}} = {\sum }_{i ∈ {π}_{0}} {\sum }_{n = 1}^{{N}_{i}} {log}_{2} ( 1 + \frac{{P}_{i , n} {λ}_{i , n}^{2}}{{σ}^{2}} ) .$$

It should be noted that if there are not enough historical achievable rate samples in the initial period, the initial estimate value for each user's action value \tilde{q}ₐ_{ᵢ}(0) can be set as \tilde{q}ₐ_{ᵢ}(0)=0, and the initial selection times \hat{τ}ₐ_{ᵢ}(0) as \hat{τ}ₐ_{ᵢ}(0)=0.

Furthermore, the step (2) specifically includes:

The estimate value for user's action value is defined as the user's expectation of the achievable rate. In Q-learning methods, it is necessary to utilize state transition probabilities to calculate action values. However, it is difficult to obtain state transition probabilities in practice. The method of the present disclosure adopts the weighted average value of the historical achievable rate of the user or the user terminal as the estimation value of the action value. The estimate value of the action value \tilde{q}ₐ_{ᵢ}(t) for user i is:

$${\tilde{q}}_{{a}_{i}} ( t ) = \{ \begin{matrix}\frac{1}{{\hat{τ}}_{{a}_{i}} ( t )} {\sum }_{τ = 0}^{t} {β}^{t - τ} {r}_{i , τ} * I ( {a}_{i} ∈ {π}_{τ} ) , {\hat{τ}}_{{a}_{i}} ( t ) \neq 0 \\ 0 , {\hat{τ}}_{{a}_{i}} ( t ) \neq 0\end{matrix} \qquad ( 9 )$$

Wherein \hat{τ}ₐ_{ᵢ}(t) represents the number of times that user i is scheduled in the scheduling period 0, 1, . . . , t, I(⋅) is the indicator function. The function value is “1” if the event in the parentheses is established, otherwise the function value is “0”. r_{i,τ} is the achievable rate of user i in period τ (as shown in equation (13)). Wherein, β∈(0,1) is the discount factor, which can reduce the weight of the sample data obtained earlier to ensure the timeliness of the data.

Equation (9) is further simplified as follows to reduce the storage pressure of the base station:

$$\begin{matrix}{\tilde{q}}_{{a}_{i}} ( t ) = \{ \begin{matrix}\frac{β {\tilde{q}}_{{a}_{i}} ( t - 1 ) {\hat{τ}}_{{a}_{i}} ( t - 1 ) + {r}_{i , t}}{{\hat{τ}}_{{a}_{i}} ( t - 1 ) + 1} , & {a}_{i} ∈ {π}_{τ} \\ β {\tilde{q}}_{{a}_{i}} ( t - 1 ) , & {a}_{i} ∉ {π}_{τ}\end{matrix} \\ = \{ \begin{matrix}β {\tilde{q}}_{{a}_{i}} ( t - 1 ) + \frac{1}{{\hat{τ}}_{{a}_{i}} ( t )} [ {r}_{i , t} - β {\tilde{q}}_{{a}_{i}} ( t - 1 ) ] , & {a}_{i} ∈ {π}_{τ} \\ β {\tilde{q}}_{{a}_{i}} ( t - 1 ) , & {a}_{i} ∉ {π}_{τ}\end{matrix}\end{matrix} \qquad ( 10 )$$

wherein t≥1, aᵢ represents the user. It should be noted that as steps (2) and (3) require iterations, the meanings of the variables aᵢ and π_{τ} are approximately equal to the variables i and ire, that is, the former variables, aᵢ or π_{τ}, is temporary variables in an iteration under the scheduling period t.

The advantage of using equation (10) is that it can use the action value of the previous period to update the action value of the next period without storing all the historical achievable rates generated by the user, thereby improving the computing efficiency.

Furthermore, the step (3) specifically comprises:

In the proposed scheduling method, the base station cannot obtain the real value of the action value when selecting a user and can only estimate the action values of all users through the previously achievable rates of the selected users. Selecting M users or user terminals with the largest sum of estimated values of action values, wherein this operation is called “Utilization” because it utilizes the existing information. However, as the action value of each user is estimated from historical data rate samples, the number of samples affects the accuracy of the estimation of the action value. When the sample size is limited, the imprecision of the action value makes it impossible to guarantee that there is no user exists among the other M₀−M users that can achieve higher system throughput. Meanwhile, due to movement or some other reasons, variables in data rates or rates may also cause users outside the currently scheduled users set to have higher action values. Therefore, it is necessary to schedule users who are outside the current scheduled users set and have been scheduled less frequently before, calculate the achievable rate of these users, increase the sample space of these users, and make the estimated value of the action values of these users more accurate. This operation is called “exploration” as it tries to explore more unknown information. When the balance of the “exploration” and “utilization” is reached, that is, after accurately estimating the action value of each user or user terminal, the system will find M users who can truly make the system obtain the highest total throughput. To balance exploration and utilization, the upper confidence bound algorithm (UCB) is adopted, and the Q value of the user or user terminal is defined as the upper bound value of the confidence interval of the action values of the user.

The upper bound value Qₐ_{ᵢ}(t) of the confidence interval of the action values of user i is defined as:

$${Q}_{{a}_{i}} ( t ) = {\tilde{q}}_{{a}_{i}} ( t ) + \sqrt{\frac{M ln ( t + 1 )}{{\hat{τ}}_{{a}_{i}} ( t )}} \qquad ( 11 )$$

The scheduled users set πₜ(t≥1) of the t scheduling period is:

$${π}_{t} = arg {max}_{{π}_{t}} {\sum }_{i ∈ {π}_{t}} {Q}_{{a}_{i}} ( t ) \qquad ( 12 )$$

Wherein, the selection of πₜ is not related to the user's Q value in the previous period, as a user won't be selected until the Q value in the previous period has been calculated. The rate calculation after the user be selected is used to update the Q value to optimize the selection. The sequence of each scheduling period is: i. calculating the action value and Q value according to the historical achievable rate and selection times; ii. selecting the user according to the Q value; iii. calculating the achievable rate of the selected user.

In the equation (12), π has been replaced by πₜ to avoid misunderstanding. The main goal of this equation (12) is to select π, which has the largest “sum of user Q values”, to be πₜ.

When the scheduling period starts, it is possible to select all the scheduling users in this scheduling period directly by utilizing equation (12), and then to calculate the achievable rates of these users according to equation (13), which may be used to update the action value and optimize the user selection in the next scheduling period. The agent utilizes equation (7) to calculate the actual achievable rate or achievable rate of each user in the scheduled users set πₜ. In the scheduling period t, the achievable rate of user i (i.e., the gain generated by user i) is:

$${r}_{i , t} = {R}_{i} ( t ) = \{ \begin{matrix}{\sum }_{n = 1}^{{N}_{i}} {log}_{2} ( 1 + \frac{{P}_{i , n} ( t ) {λ}_{i , n}^{2} ( t )}{{σ}^{2}} ) , i ∈ {π}_{t} \\ 0 , i ∉ {π}_{t}\end{matrix} \qquad ( 13 )$$

The data rate newly generated may update the estimated values of the action values for all users and the upper bound value of the confidence interval for the action values, and then to be applied for users' selection in the t+1 period.

The difference between the method of the present disclosure and the common greedy algorithm is that the method selects users firstly and then calculate performance (while greedy algorithm needs to calculate performance firstly and then select users according to performance). Therefore, the method needs to select users and then calculate the use's actual performance to optimize the next user's selection. Through continuous optimization, the users' selection can achieve optimal performance eventually.

As shown in equations of (11) and (12), the method of the present disclosure traverses all users in the initial stage, avoiding the scenarios those some users have never been selected. After multiple rounds of users scheduling, the number of selections of each user increases continuously, the confidence interval gradually converges, and the user's Q value gets equal to the action value. The base station may select the users with higher action value and maximizes the system throughput. From a long-term perspective, the method can be used to balance exploration and utilization, also it guarantees long-term system performance. Additionally, the Q value of the users, who have not been scheduled for a long time, may grow continuously without an upper bound value, so that these users may be scheduled by the system eventually. Therefore, the method can avoid “extreme unfairness” scenarios.

Furthermore, the specific steps of step (4) are listed as below:

From the t scheduling period (t≥1), repeating steps (2) and (3) until for any user i∈{M₀},

$$\sqrt{\frac{M ln ( t + 1 )}{{\hat{τ}}_{{a}_{i}} ( t )}} \to 0 ,$$

the method converges and obtains the optimal scheduled users set π*.

In conclusion, the difference between the method of the present disclosure and the common greedy algorithm is that the method selects users firstly and then calculate performance (while greedy algorithm needs to calculate performance firstly and then select users according to performance). Therefore, the method needs to select users and then calculate the use's actual performance to optimize the next users' selection. Through continuous optimization, the users' selection can achieve optimal performance eventually.

Thus, the idea of the method is to directly select all the scheduled users in this scheduling period by using equation (12), and then calculate the achievable rates of these users according to equation (13), which may update the action value and optimize the users' selection in the next scheduling period.

The method of selecting users based on historical data cannot guarantee that the optimal scheduled set be selected in each period before the method convergences, i.e., πₜ≠π*, as there is not enough amount of data to support an accurate user rate model. The accurate data may not be obtained (evaluated by Q-learning) until a certain number of samples can be obtained. In order to obtain accurate data for all users, we utilize a confidence upper bound method (Qₐ_{ᵢ}(t)), so that the control system may select the users those have be selected with fewer times before convergence so that to allow these users to be accurately evaluated.

Therefore, πₜ is obtained by comparing Qₐ_{ᵢ}(t), and then πₜ=π* after achieving convergence.

The additional advantage of the method is that the method may select users firstly and then calculate the system performance achieved by these users. Distinguishing from the greedy algorithm, which calculates performance firstly and then selects users, the present disclosure can reduce the scheduling delay significantly (the time from all users initiating scheduling applications to the base station completing users' selection).

The specific exemplary embodiments of the present disclosure may be described in detail below with reference to the accompanying drawings.

A division method for community users based on an improved support vector machine (SVM) algorithm, the method comprises the following steps:
(i). according to the characteristics of 5G communication system, establishing a problem model of the communication scenario model between community mobile users to the base station;

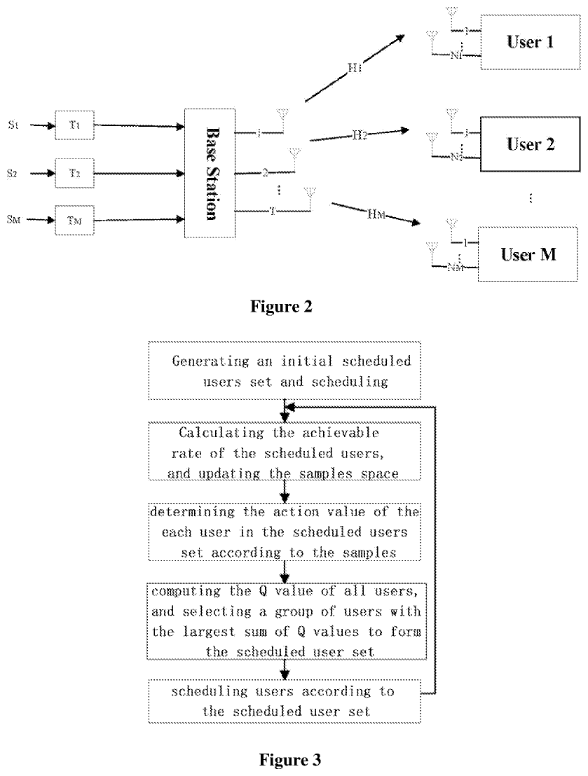

FIG. 2 is a communication system model diagram of the present disclosure, wherein the total number of transmit antennas of the base station is T, and the maximum number of users that the system can schedule in a single scheduling period is M. The system selects M users from M₀(M₀≥M) users to provide services in each scheduling period. User m is equipped with Nₘ receive antennas,

m=1, 2, . . . , M₀, and Nₘ≤T,

$${H}_{m} = {( \begin{matrix}{h}_{1 , 1} & ⋯ & {h}_{1 , T} \\ ⋮ & ⋱ & ⋮ \\ {h}_{{N}_{m} , 1} & ⋯ & {h}_{{N}_{m} , T}\end{matrix} )}_{{N}_{m} * T}$$

is the channel state matrix of user m. wherein, h_{i,j} represents the spatial channel fading coefficient rank(Hₘ)=Nₘ from the j transmit antenna to the i receive antenna. Setting sₘ represent the transmitted signal vector sent by the base station to user m, and each value contains the information to be transmitted Tₘ that is the precoding matrix of user m, then the received signal yₘ of user m is:

yₘ=HₘTₘsₘ+nₘ (1)

The precoding is set as Tₘ= [symbol] ₘ⁰Vₘ¹, [symbol] ₘ⁰ is composed of the right singular vectors corresponding to the zero singular values of the joint matrix [symbol] ₘ, and Vₘ¹ is composed of the right singular vectors corresponding to the non-zero singular values of the matrix Hₘ [symbol] ₘ⁰. At the point, the signal interference of other users has been eliminated, and the achievable rate Rₘ of user m can be obtained:

$${R}_{m} = {\sum }_{n = 1}^{{N}_{m}} {log}_{2} ( 1 + \frac{{P}_{m , n} {λ}_{m , n}^{2}}{{σ}^{2}} ) \qquad ( 7 )$$

(ii). recording the historical achievable rates of each user at the base station, and utilizing these rates as samples to estimate the action value of each user through the Q-learning method;
(iii). applying the upper confidence bound algorithm to balance exploration and utilization, defining the user's Q value as the upper bound value of the confidence interval for the user's action value, and then selecting users according to the Q value. After selecting users, the base station calculates the achievable rate of each selected user;
(iv). repeating steps (ii) and (iii). After the method converges, the user's Q value is equal to the real action value. Meanwhile, the users selected by the base station scheduling step (iii) can achieve the highest system performance.

Correspondingly, the present disclosure also discloses a multi-user scheduling system based on reinforcement learning for 5G IoT (Internet of Things), comprising: a performance computing module and a logic computing module.

The performance computing module calculates the achievable rate or actual achievable rate of each user in the scheduled users set and applies these rates as the user's historical rates to provide foundation for the system to evaluate the user's action value.

The logic operation module generates an initial scheduled users' set, evaluates the estimated value of each user's action value under the current scheduling period, determines the upper bound value of the confidence interval of each user's action value, and determines the scheduled users set under the current scheduling period.

FIG. 3 is a schematic flowchart of the user scheduling method of the present disclosure. In the initial stage of the method, the initial scheduled users set is generated through step (a), and then step (b) will be executed to estimate the action value of each user at each subsequent scheduling period. The present disclosure adopts the weighted average value of the historical achievable rates of the user or user terminal as the estimated value of the action value. The estimated value of the action value \tilde{q}ₐ_{ᵢ}(t) of user i is:

$${\tilde{q}}_{{a}_{i}} ( t ) = \{ \begin{matrix}\frac{1}{{\hat{τ}}_{{a}_{i}} ( t )} {\sum }_{τ = 0}^{t} {β}^{t - τ} {r}_{i , τ} * I ( {a}_{i} ∈ {π}_{τ} ) , {\hat{τ}}_{{a}_{i}} ( t ) \neq 0 \\ 0 , {\hat{τ}}_{{a}_{i}} ( t ) = 0\end{matrix} = \{ \begin{matrix}β {\tilde{q}}_{{a}_{i}} ( t - 1 ) + \frac{1}{{\hat{τ}}_{{a}_{i}} ( t )} [ {r}_{i , t} - β {\tilde{q}}_{{a}_{i}} ( t - 1 ) ] , {a}_{i} ∈ {π}_{τ} \\ β {\tilde{q}}_{{a}_{i}} ( t - 1 ) , {a}_{i} ∉ {π}_{τ}\end{matrix}$$

As the estimated value of the action value of each user or user terminal may be inaccurate, the present disclosure proposes step (c) to balance exploration and utilization in order to avoid the method falling into a local optimal situation, and the Q value of a user is defined as the upper bond value of the confidence interval of the user's action value, and applies the Q value as a criterion for user selection. The Q value of a user i is:

$${Q}_{{a}_{i}} ( t ) = {\tilde{q}}_{{a}_{i}} ( t ) + \sqrt{\frac{M ln ( t + 1 )}{{\hat{τ}}_{{a}_{i}} ( t )}}$$

The set of scheduled users in the t scheduling period is:

$${π}_{t} = arg {max}_{π} {\sum }_{i ∈ π} {Q}_{{a}_{i}} ( t )$$

For user i∈{M₀}, the achievable rate

$${r}_{i , t} = \{ \begin{matrix}{\sum }_{n = 1}^{{N}_{i}} {log}_{2} ( 1 + \frac{{P}_{i , n} {λ}_{i , n}^{2}}{{σ}^{2}} ) , i ∈ {π}_{t} \\ 0 , i ∉ {π}_{t}\end{matrix} .$$

Repeating sept (b) and (c) until the method converges when

$$\sqrt{\frac{M ln ( t + 1 )}{{\hat{τ}}_{{a}_{i}} ( t )}} \to 0 ,$$

for any user i∈{M₀}, and then obtaining the optimal scheduled users set π*.

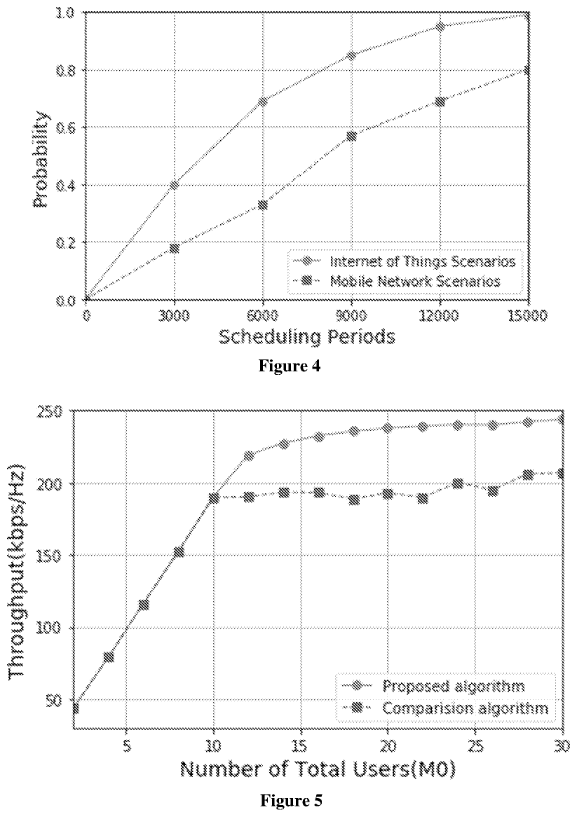

FIG. 4 is schematic diagram of convergence time situation of the present disclosure and shows the condition of the convergence time of the present disclosure. In a MU-MIMO system with a single base station, the number of transmit antennas of the base station is T=80, the total number of users is M₀=20, the number of the receive antennas of the user m is Nₘ=4(m=1, 2, . . . M₀). In the downlink of the system, the transmit power of each antenna is represented by P_{avg}, its upper limit is 10 W, the noise power σ²=10⁻¹⁰ W, and the discount factor β=0.8. As shown in the FIG. 4, in the IoT scenario with relatively fixed nodes, the method may converge with a high probability within 9000 scheduling periods, while the method is difficult to converge quickly in the scenario where users move frequently. Meanwhile, if new users frequently appear in the environment or users switch base stations due to movement, the convergence time of the method will be further extended. Therefore, the present disclosure is more suitable for 5G IoT systems with relatively fixed nodes.

FIG. 5 shows a comparison of the system throughput after convergence of the method of the present disclosure and other scheduling methods. The comparison scheduling method is the greedy algorithm, the number of transmit antennas T is set to 40, and Nₘ=4(m=1, 2, . . . M₀). When M₀≤10, The greedy algorithm has the identical total throughput as this method, and the reason is that the total number of users in the system does not exceed the maximum number of users that can be scheduled, and the system can schedule all users at this time. When M₀>10, the total throughput obtained by this method may be higher than that obtained by the greedy algorithm as the greedy algorithm itself is a sub-optimal user selection algorithm, which cannot obtain the highest throughput. Although a longer convergence time may be needed, the total throughput obtained by the method after convergence may be significantly higher than that of the greedy algorithm, and the long-term performance of the method of the present disclosure is higher than that of the greedy algorithm, which may ensure that the system performance will not be affected.

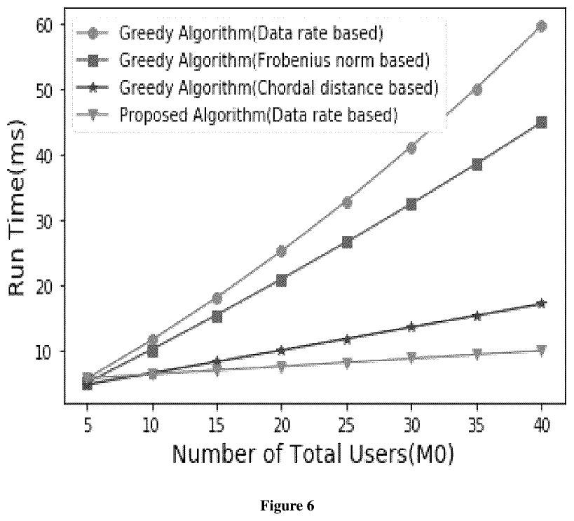

FIG. 6 shows a comparison between the user scheduling delay of the method of the present disclosure and other scheduling methods, and the number of transmit antennas is T=40. Among the comparison methods, the user selection method adopts a greedy algorithm, while the Frobenius norm or other methods are used to reduce the amount of computation respectively when characterizing user-achievable data rates. In fact, the method proposed in the present disclosure does not prevent the use of the Frobenius norm or other methods to further reduce the amount of computation. In the method proposed by the present disclosure, the base station, at each scheduling period, needs to go through three stages: action value evaluation, scheduling set update, and calculation of the achievable rate.
a). In the stage of action value evaluation, the base station estimates the action value of M₀ users by using the method of equation (10), and the computational complexity is O(M₀).
b). In the stage of scheduling set update, the base station calculates the Q value of M₀ users and finds the M users with the largest sum of Q values to form the scheduled users set, and the computational complexity is O(M₀).
c). In the stage of calculation of the achievable rate, the base station calculates the achievable rates of M₀ users respectively. Wherein, the amount of computation required to calculate the joint channel matrix SVD for one time is O(T³), and T is the number of antennas at the base station, so the computational complexity of this stage is O(MT³).

Therefore, the computational complexity of one scheduling period is O(MT³+M₀) when adopting the method of the present disclosure. Table 1 shows the computational complexities of various scheduling algorithms.

TABLE 1
the computational complexities of scheduling algorithms

| | Computational |
|---|---|
| Algorithms | complexities |
| Greedy algorithm (based on user rate) | O(M₀T³M²) |
| Greedy algorithm (based on F-form) | O(M₀T³M²) |
| Greedy algorithm (based on chord distance) | O(M₀T³) |
| The method of the present disclosure | O(MT³ + M₀) |
| (based on user rate) | |

When the total number of users is massive, the computational complexity of this method is much lower than that of the greedy algorithm. Meanwhile, the computational complexity of the method does not increase too much even the total number of users increases. Therefore, the proposed method can ensure that the system maintains a low computational load even if there are enormous IoT nodes in the 5G network.

The applicant of the present disclosure has depicted and described the embodiments of the present disclosure in detail with reference to the accompanying drawings, but those skilled in the art should understand that the above embodiments are only exemplary embodiments of the present disclosure, and the detailed description is only to help readers to understand the ideas better rather than to limit the protection scope of the present disclosure. On contrary, any improvement or modification based on the spirit of the present disclosure should fall within the protection scope of the present disclosure.

1. A multi-user scheduling method based on reinforcement learning for a 5G IoT (Internet of Things system), comprising:
(a) calculating a achievable rate of each user in a set, according to the communication scenario model of the 5G IoT;
(b) generating an initial scheduled users set according to the achievable rate of the each user;
(c) according to the achievable rate of the each user and a number of times the each user being scheduled, evaluating an estimated value of an action value of the each user under a current scheduling period by utilizing Q-learning method;
(d) obtaining an upper bound value of a confidence interval for the action value of the each user;
(e) determining a scheduled users set in the current scheduling period according to the upper bound value of the confidence interval of the action value of the each user;
(f) calculating one more time the achievable rate of the each selected user under the current scheduling period according to the scheduled users set under the current scheduling period,
(g) returning to (c) until the estimated value of the action value of the each user converges to the achievable rate of the each user in the current scheduling period, and then outputting the scheduled users set in (e) performed at last round as a result of a next scheduling period.

2. The method of claim 1, wherein in (a): the achievable rate, representing as Rₘ, of a user m, is:
$${R}_{m} = {\sum }_{n = 1}^{{N}_{m}} {log}_{2} ( 1 + \frac{{P}_{m , n} {λ}_{m , n}^{2}}{{σ}^{2}} )$$
wherein, P_{m,n} is a transmission power of the user m in a parallel channel n, σ2 is an additive white Gaussian noise power, λ_{m,n} is a non-zero singular value of Hₘ [symbol] ₘ⁰, and Nₘ is a number of antennas of the user m, specially:
$${ℍ}_{m} = ( \begin{matrix}\begin{matrix}\begin{matrix}\begin{matrix}\begin{matrix}{H}_{1} \\ ⋮\end{matrix} \\ {H}_{m - 1}\end{matrix} \\ {H}_{m + 1}\end{matrix} \\ ⋮\end{matrix} \\ {H}_{M}\end{matrix} ) = ( \begin{matrix}{𝕌}_{m}^{1} & {𝕌}_{m}^{0}\end{matrix} ) ( \begin{matrix}0 \\ 0\end{matrix} ) {( \begin{matrix}{𝕍}_{m}^{1} & {𝕍}_{m}^{0}\end{matrix} )}^{H}$$
$${H}_{m} {𝕍}_{m}^{0} = ( \begin{matrix}{U}_{m}^{1} & {U}_{m}^{0}\end{matrix} ) ( \begin{matrix}{\sum }_{m}^{1} & 0 \\ 0 & 0\end{matrix} ) {( \begin{matrix}{V}_{m}^{1} & {V}_{m}^{0}\end{matrix} )}^{H}$$
wherein [symbol] ₘ is a joint matrix of a channel matrix of other users except the user m, and the above equation is the singular value decomposition of [symbol] ₘ.

3. The method of claim 1, wherein (b) further comprising:
(b1) defining the scheduled users set Ψ=Ø, and the set of all users in the environment A={M₀};
(b2) for each user x in the set A−Ψ, defining Ψₓ=Ψ+{x}, and calculate the data rate R_{Ψ}_{ₓ} of each Ψₓ as:
$${R}_{{Ψ}_{x}} = {\sum }_{m ∈ {Ψ}_{x}} {R}_{m}$$
wherein, Rₘ representing the achievable rate of user m;
(b3) updating the scheduled users set Ψ=Ψ+{x*}, wherein, the user x* is x*=argmax_{x∈A-Ψ}R_{Ψ}_{ₓ};
(b4) returning to (b2), until |Ψ|=M, then the initial scheduled users set is π₀=Ψ, wherein, the maximum number M of users that can be scheduled at same time is determined by:
$${\sum }_{i = 1 , i \neq m}^{M} {N}_{i} \leq T$$
wherein, T is a number of antennas, Nᵢ is a number of antennas for the each user.

4. The method of claim 1, wherein in(c):
an estimated value of action value \tilde{q}ₐ_{ᵢ}(t) of a user i is:
$${\tilde{q}}_{{a}_{i}} ( t ) = \{ \begin{matrix}\frac{1}{{\hat{τ}}_{{a}_{i}} ( t )} {\sum }_{τ = 0}^{t} {β}^{t - τ} {r}_{i , τ} * I ( {a}_{i} ∈ {π}_{τ} ) , {\hat{τ}}_{{a}_{i}} ( t ) \neq 0 \\ 0 , {\hat{τ}}_{{a}_{i}} ( t ) = 0\end{matrix}$$
wherein \hat{τ}ₐ_{ᵢ}(t) represents a number of times that user i is scheduled in a scheduling period 0, 1, . . . , t; I(⋅) is an indicator function, the indication function value is 1 if an event in the parentheses is established, otherwise the indication function value is 0;
β∈(0,1) is a discount factor; r_{i,τ} is an achievable rate of user i in τ scheduling period.

5. The method of claim 4, wherein the estimated value of action values \tilde{q}ₐ_{ᵢ}(t) of the user i is simplified as:
$${\tilde{q}}_{{a}_{i}} ( t ) = \{ \begin{matrix}\frac{β {\tilde{q}}_{{a}_{i}} ( t - 1 ) {\hat{τ}}_{{a}_{i}} ( t - 1 ) + {r}_{i , t}}{{\hat{τ}}_{{a}_{i}} ( t - 1 ) + 1} , {a}_{i} ∈ {π}_{t} \\ β {\tilde{q}}_{{a}_{i}} ( t - 1 ) , {a}_{i} ∉ {π}_{τ}\end{matrix} = \{ \begin{matrix}β {\tilde{q}}_{{a}_{i}} ( t - 1 ) + \frac{1}{{\hat{τ}}_{{a}_{i}} ( t )} [ {r}_{i , t} - β {\tilde{q}}_{{a}_{i}} ( t - 1 ) ] , {a}_{i} ∈ {π}_{τ} \\ β {\tilde{q}}_{{a}_{i}} ( t - 1 ) , {a}_{i} ∉ {π}_{τ}\end{matrix}$$
wherein, t≥1.

6. The method of claim 4, wherein in (d):
the upper bound value of the confidence interval Qₐ_{ᵢ}(t) of the user i:
$${Q}_{{a}_{i}} ( t ) = {\tilde{q}}_{{a}_{i}} ( t ) + \sqrt{\frac{M ln ( t + 1 )}{{\hat{τ}}_{{a}_{i}} ( t )}}$$
wherein, M is a maximum number of users that can be scheduled at the same time.

7. The method of claim 6, further comprising:
wherein in (g), the action value of the each user converges to the achievable rate of the each user, includes:
$$\sqrt{\frac{M ln ( t + 1 )}{{\hat{τ}}_{{a}_{i}} ( t )}} \to 0$$

8. The method of claim 1, wherein (e) comprising:
the scheduled users set πₜ in the current scheduling period is
$${π}_{t} = arg {max}_{{π}_{t}} {\sum }_{i ∈ {π}_{t}} {Q}_{{a}_{i}} ( t )$$
wherein, Qₐ_{ᵢ}(t) is the upper bound value of the confidence interval of a user i, and πₜ is the maximum value of a sum of Qₐ_{ᵢ}(t).

9. The method of claim 1, wherein:
in (c), evaluating the estimated value of each user's action value under the current scheduling period includes:
if the current scheduling period is the first scheduling period, setting the estimated value of each user's action value \tilde{q}ₐ_{ᵢ}(0)=0.

10. A multi-user scheduling system based on reinforcement learning for a 5G IoT (Internet of Things system), comprising:
a performance computing module and a logic operating module;
the performance computing module computes the achievable rate of an each user in a scheduled users set and utilizes the achievable rates of the each user as a historical rate of the each user to provide a function for the multi-user scheduling system to evaluate the each user's action value;
the logic operating module generates an initial scheduled users set, evaluates an estimated value of the each user's action value under a current scheduling period, determines an upper bound value of a confidence interval of the each user's action value, and determines the scheduled users set under the current scheduling period.
